(19) United States
(12) Patent Application Publication
(10) Pub. No.: US 2008/0240687 A1
(43) Pub. Date: Oct. 2, 2008

(54) APPARATUS AND METHOD FOR REPRODUCING AUDIO/VIDEO DATA OF INFORMATION STORAGE MEDIUM

(75) Inventors: Kwang-min KIM, Seoul (KR); Kil-soo JUNG, Osan-si (KR); Sung-wook PARK, Seoul (KR); Sung-ryeul RHYU, Yongin-si (KR); Man-seok KANG, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/962,603

(22) Filed: Dec. 21, 2007

(30) Foreign Application Priority Data
Mar. 28, 2007 (KR) 2007-30378

(51) Int. Cl. H04N 5/00; G06F 17/30

(52) U.S. Cl. 386/126; 707/104.1; 707/E17.009; 386/E05.064

(57) ABSTRACT

An apparatus and method of reproducing audio/video (A/V) data of an information storage medium, by which various reproduction modes can be provided. The apparatus includes a controller to download, via a network, data used to reproduce the A/V data and to generate as update information file information used to reproduce the downloaded data and the A/V data; and a local storage medium to store the update information. The controller stores newly downloaded and generated update information in the local storage medium while maintaining previously downloaded and generated update information in the local storage medium.

### CROSS-REFERENCE TO RELATED APPLICATION

This application claims the benefit of Korean Application No. 2007-30378, filed in the Korean Intellectual Property Office on Mar. 28, 2007, the disclosure of which is incorporated herein by reference.

### BACKGROUND OF THE INVENTION

1. Field of the Invention

Aspects of the present invention relate to an apparatus and method of reproducing audio/video (A/V) data of an information storage medium, by which various reproduction modes can be provided.

2. Description of the Related Art

FIG. 1 shows a configuration of a conventional reproducing apparatus 100 and a storage medium 110. The storage medium 110 illustrated in FIG. 1 may be a Blu-ray disc (BD) or the like. The reproducing apparatus 100 includes a reading unit 120 that reads out an audio/video (A/V) stream recorded in the storage medium 110 and a reproducing unit that reproduces the A/V stream. The reproducing unit includes a demuxer 130 and decoders 140 to 180. The demuxer 130 divides the A/V stream into a video stream, an audio stream, a bitmap caption stream, a text caption stream, and an interactive graphic stream, and transfers the streams to a video decoder 140, an audio decoder 150, a presentation graphic decoder 160, a text caption decoder 170, and an interactive graphic decoder 180, respectively. Data decoded by the decoders 140 to 180 are mixed to be output to a display 190 and a speaker 191.

FIG. 2 shows a structure of the A/V stream recorded in the storage medium 110. The A/V stream is constructed with a plurality of clips 222, each of which is a recording unit. In order to reproduce the clips 222, information on attributes of the compressed A/V data is required. For this reason, each of the clips 222 contains clip information 221. The clip information 221 includes an entry point map containing an A/V attribute of a corresponding clip and position information of an entry point that can be randomly accessed in units of a predetermined interval. A play list 211 is a basic reproducing unit. The play list 211 is constructed by connecting a plurality of play items 212 to 214. In addition, the play list 211 contains navigation information used to define an order of connection and reproduction of clip files and to control reproduction of the A/V data. Each of the play items 212 to 214 corresponds to a portion of the clips 222. More specifically, starting and ending of reproduction of the clips 222 are indicated by the play items 212 to 214. The corresponding positions in an actual clip 222 are obtained with reference to the clip information 221.

FIG. 3 shows an example of a structure of the play list 211. The play list 211 includes stream information 212 of a play item #0 and stream information 213 of a play item #1. Video stream information 311, audio stream information 312, presentation graphic information 313, and interactive graphic information 314 are recorded in the play item #0. Video stream information 321, audio stream information 322, presentation graphic information 323, and interactive graphic information 324 are recorded in the play item #1.

For caption reproduction, the reproducing apparatus 100 selects a packet identifier (PID) for a packet containing caption data among a plurality of packets multiplexed in a moving picture stream, based on the presentation graphic information 313 and 323 of the stream information contained in the play list to be reproduced, and sets the PID in the demuxer 130. Data having the PID is transferred to the presentation graphic decoder 160 or the text caption decoder 170, so that the data is decoded and output to the display 190. If the A/V stream contains caption data, a user selects one of a plurality of captions in presentation graphic information 313, such as play item #0, 212 through an interface, for example, an on-screen display (OSD), to reproduce the A/V stream.

In the conventional reproducing apparatus 100, the A/V data alone in the storage medium 110 is not simply reproduced; instead, the A/V data in the storage medium 110 is reproduced together with supplementary data. The supplementary data is downloaded via a network and stored in the reproducing apparatus 100. Accordingly, there is a need to use the downloaded supplementary data efficiently.

### SUMMARY OF THE INVENTION

Aspects of the present invention provide an apparatus and method of reproducing audio/video (A/V) data of an information storage medium, by which various reproduction modes can be provided.

According to an aspect of the present invention, an apparatus to reproduce audio/video (A/V) data of an information storage medium is provided. The apparatus comprises a controller to download, via a network, data used to reproduce the A/V data and to generate as update information file information used to reproduce the A/V data together with the downloaded data; and a local storage medium to store the update information, wherein the controller stores newly downloaded and generated update information in the local storage medium while maintaining previously downloaded and generated update information in the local storage medium.

According to another aspect of the invention, the update information includes studio/disk information indicating a producer of the downloaded data and a storage medium associated with the downloaded data, version information identifying the update information, and file information used to update files of the information storage medium.

According to another aspect of the invention, the file information includes a file list of the downloaded data required to update the files of the information storage medium and a file list of the information storage medium with which files of the downloaded data are to be bound.

According to another aspect of the invention, the file information includes a binding unit manifest file (BUMF).

According to another aspect of the invention, the update information further includes all the files indicated by the BUMF.

According to another aspect of the invention, the update information includes studio/disk information indicating a producer of the downloaded data and a storage medium associated with the downloaded data, version information identifying the update information, and a virtual file system information used to reproduce the A/V data together with the downloaded data.

According to another aspect of the invention, the virtual file system information includes a virtual package.

According to another aspect of the invention, the downloaded data includes stream data used by the update information, a database file corresponding to the stream data, and file information used for file updating of the information storage medium.

According to another aspect of the invention, the stream data includes caption data, audio data, trailer data, and application data.

According to another aspect of the invention, the controller downloads, via the network, the data used to reproduce the A/V data and stores the previously downloaded and generated update information in the local storage medium every time the file information used to reproduce the A/V data together with the downloaded data is generated as the update information.

According to another aspect of the present invention, an apparatus to reproduce A/V data of an information storage medium is provided. The apparatus comprises a local storage medium to store update information that is file information used to reproduce the A/V data, and data downloaded via a network; an A/V decoder to decode at least one of the A/V data stored in the information storage medium and the downloaded data stored in the local storage medium; and a controller to control the A/V decoder to decode, based on the update information, at least one of the A/V data stored in the information storage medium and the downloaded data stored in the local storage medium.

According to another aspect of the invention, the controller provides a menu to a user so that the user can select a reproducing mode based on the update information.

According to another aspect of the invention, when the controller receives from the user an input indicating that the latest update information is selected in response to providing the menu, the controller may control the A/V decoder to decode, based on the latest update information stored in the local storage medium, at least one of the A/V data stored in the information storage medium and the downloaded data stored in the local storage medium.

According to another aspect of the invention, when the controller receives from the user an input indicating that the A/V data stored in the information storage medium is to be reproduced in response to providing the menu, the controller may control the A/V decoder to decode the A/V data stored in the information storage medium without referring to the local storage medium.

According to another aspect of the invention, when the controller receives from the user an input indicating that an update list display is selected, the controller provides to the user a list of the update information stored in the local storage medium, and when the controller receives from the user an input indicating that the update information is selected in response to providing the list, the controller controls the A/V decoder to decode, based on the selected update information, at least one of the A/V data stored in the information storage medium and the downloaded data stored in the local storage medium.

According to another aspect of the present invention, a method of reproducing A/V data of an information storage medium is provided. The method comprises downloading via a network data used to reproduce the A/V data; generating as update information file information used to reproduce the A/V data together with the downloaded data; and storing the update information in a local storage medium, wherein newly downloaded and generated update information is stored in the local storage medium while maintaining previously downloaded and generated update information in the local storage medium.

According to another aspect of the present invention, a method of reproducing A/V data of an information storage medium is provided. The method comprises decoding at least one of A/V data stored in the information storage medium and downloaded data downloaded via a network and stored in a local storage medium based on update information that is file information used to reproduce the A/V data together with the downloaded data and that is stored in the local storage medium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view illustrating a configuration of a conventional reproducing apparatus;

FIG. 2 is a view illustrating a structure of an A/V stream recorded in a storage medium illustrated in FIG. 1;

FIG. 3 is a view illustrating a structure of play list information;

FIG. 4 is a schematic view illustrating a reproducing apparatus according to an embodiment of the present invention;

FIG. 5 is a view illustrating a configuration of a local storage medium illustrated in FIG. 4;

FIG. 6A illustrates a first example of update information stored in the local storage medium of FIG. 5;

FIG. 6B illustrates a second example of update information stored in the local storage medium of FIG. 5;

FIG. 6C illustrates a third example of update information stored in the local storage medium of FIG. 5;

FIG. 7 is a view illustrating a structure of a binding unit manifest file (BUMF) according to an embodiment of the present invention;

FIG. 8 is a view explaining a concept of a virtual package;

FIG. 9 is a view illustrating an example of a menu screen which is provided to a user so as to reproduce data based on update information stored in a local storage medium, according to an embodiment of the present invention;

FIG. 10 is a flowchart illustrating a method of downloading supplementary data via a network;

FIG. 11 is a flowchart illustrating a method of storing update information in a local storage medium, according to an embodiment of the present invention; and

FIG. 12 is a flowchart illustrating a method of reproducing data based on update information stored in a local storage medium, according to an embodiment of the present invention.

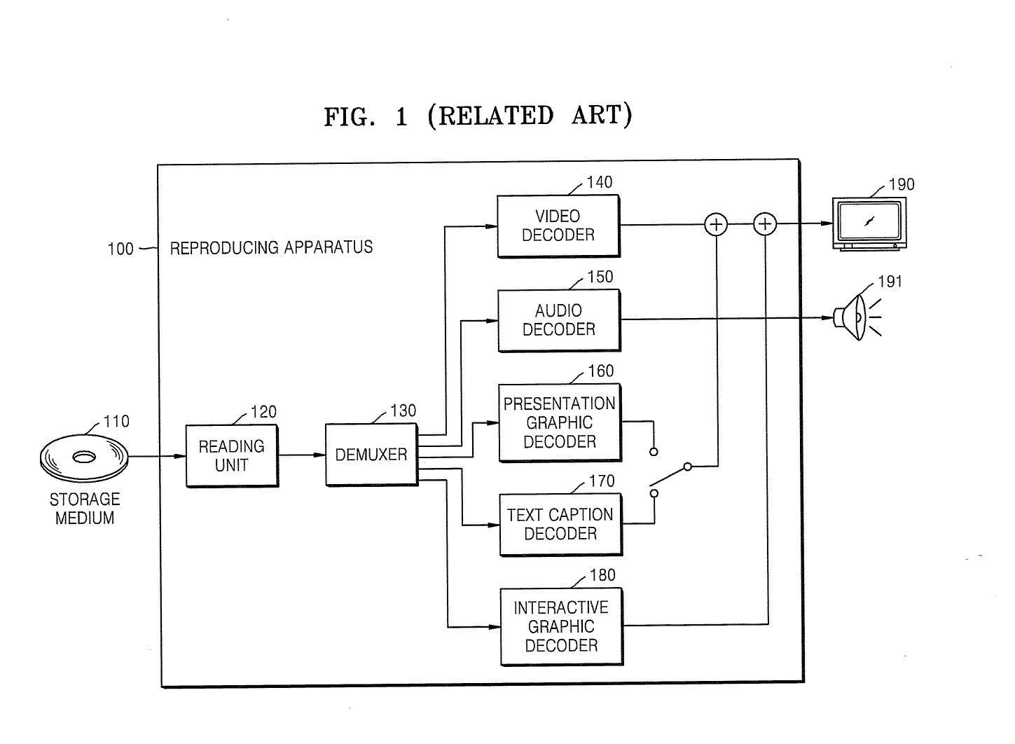

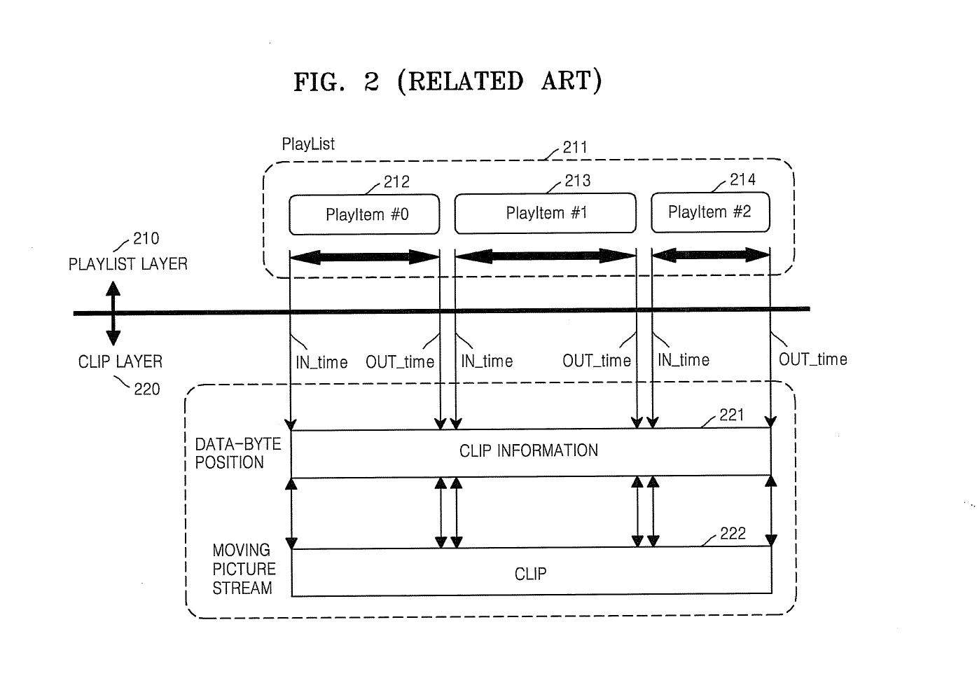

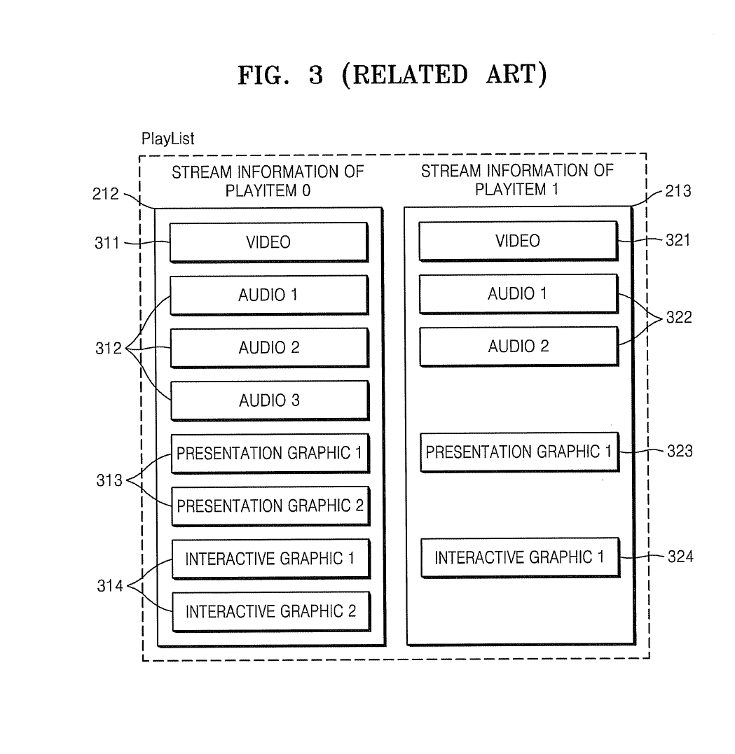

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

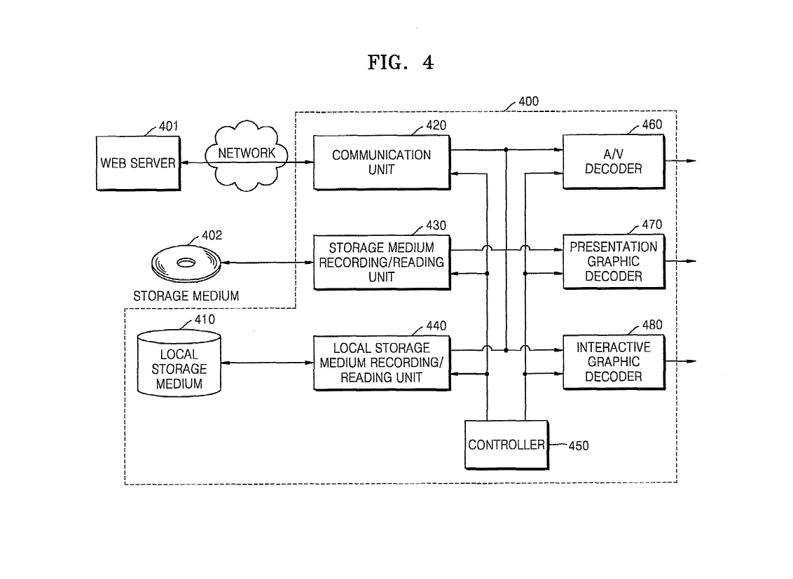

FIG. 4 shows a reproducing apparatus 400 according to an embodiment of the present invention. The reproducing apparatus 400 includes a local storage medium 410, a communication unit 420, a storage medium recording/reading unit 430, a local storage medium recording/reading unit 440, a controller 450, an audio/video (A/V) decoder 460, a presentation graphic decoder 470, and an interactive graphic decoder 480. According to other aspects of the invention, the recording apparatus 400 may include additional and/or different units. Similarly, the functionality of two or more of the above-described units may be incorporated into a single component. The reproducing apparatus 400 may be a home entertainment device (such as a BD player), a video game device, a desktop computer, or other apparatus capable of reproducing data on an information storage medium.

The local storage medium 410 is a storage unit that stores update information according to an embodiment of the present invention. The local storage medium 410 may be a hard disk, a flash memory, or the like.

The communication unit 420 transmits a request for downloading data reproduced together with A/V data stored in a storage medium 402 via a network to a web server 401 (or other data source) and receives the data via the network from the web server 401. “Downloaded data” refers to data other than data stored in the storage medium 402. Downloaded data is data that a user selects and downloads so as to update and reproduce the data stored in the storage medium 402. The storage medium 402 may be an optical storage medium, such as a DVD, HD-DVD, or BD, or another type of removable storage medium.

The downloaded data may include stream data for the update, a database file corresponding to the stream data, and/or file information used to update files stored in the storage medium 402. The stream data may include caption data, audio data, trailer data, and/or application data used to perform a specific function or to indicate a menu. The database file corresponding to the stream data includes clip information and/or a play list used to control reproduction of the stream data. The file information used to update the files in the storage medium 402 may be a binding unit manifest file (BUMF), which is described later in detail.

The storage medium recording/reading unit 430 records the data in the storage medium 402 or reads out the data from the storage medium 402. The local storage medium recording/reading unit 440 records the data in the local storage medium 410 or reads the data from the local storage medium 410.

The A/V decoder 460 decodes the received A/V data. The presentation graphic decoder 470 decodes received presentation graphic data. The interactive graphic decoder 480 decodes received interactive graphic data.

The controller 450 controls components of the reproducing apparatus 400. When data is downloaded from the web server 401, the controller 450 generates a virtual file system by combining information on the downloaded data with the A/V data stored in the storage medium 402. The controller controls the reproduction of the A/V data of the storage medium 402 and the downloaded data based on the virtual file system. The controller may control the A/V decoder to decode at least one of the A/V data stored in the storage medium 402 and the downloaded data stored in the local storage medium 410. As used herein, “at least one” refers to either the A/V data stored in the storage medium 402, the downloaded data stored in the local storage medium 410, or both the A/V data and the downloaded data.

When the data is downloaded from the web server 401 one or more times, the controller 450 stores update information generated each time the data is downloaded as history information in the local storage medium 410. The controller 450 stores in the local storage medium 410 the latest update information among the update information generated each time the data is downloaded from the web server 401, without removing the previous update information from the local storage medium 410. The controller 450 stores the previous update information as well as the latest update information, or history information, in the local storage medium 410. Since the previous update information as well as the latest update information is stored in the local storage medium 410, the user can select the previous update information for reproduction.

The previous update information stored in the local storage medium 410 may be needed for several reasons. First, when reproduction is performed based on a newly downloaded, generated virtual package, reproduction based on a previous virtual package or reproduction of the storage medium cannot be performed until the downloaded data is removed. In other words, the reproduction based on the previous virtual package or the reproduction of the disc can be performed only if the downloaded data is removed.

Second, the data downloaded via the network may be associated with an update caused by an error of the data of the storage medium and/or by an addition of a new function to the storage medium. Here, since the new version of the update content is extremely unlikely to include the previous version of the update contents, the previous version of the update information may be needed.

Third, the virtual package updated based on the first download and the virtual package updated based on the second download may have entirely different content according to selection of a user or a content provider. For example, the first virtual package may be updated based on downloaded Korean captions, but the second virtual package may be updated based on downloaded Japanese audio. For this reason, it may be necessary to maintain the previous version virtual package, such as the first virtual package. According to other aspects of the invention, the previous virtual packages (or previous update information) may be removed from the local storage medium 410 upon instruction from the user or if no free space remains on the local storage medium 410.

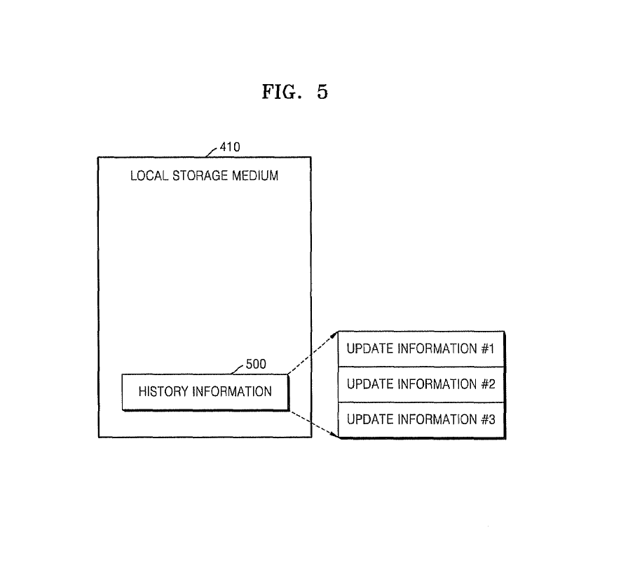

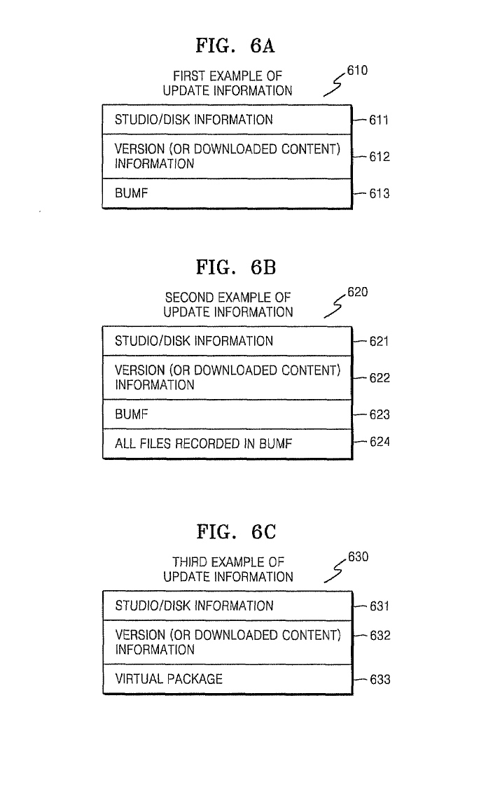

FIG. 5 illustrates a configuration of the local storage medium 410 illustrated in FIG. 4, according to an embodiment of the present invention. History information 500 is stored in a predetermined region of the local storage medium 410. The history information 500 includes update information #1, update information #2, and update information #3. The update information is file information used to reproduce the downloaded data and the data stored in the storage medium 402. Examples of the update information are illustrated in FIGS. 6A to 6C.

FIG. 6A shows a first example of the update information included in the history information 500 according to an embodiment of the present invention. Update information 610 according to the first example includes studio/disk information 611, version (or downloaded content) information 612, and a binding unit manifest file (BUMF) 613. The studio/disc information 611 indicates a producer of the downloaded data and a storage medium associated with the downloaded data. The version information 612 serves as an identifier for the update information 610. The BUMF 613 indicates file information used to update files of the storage medium 402.

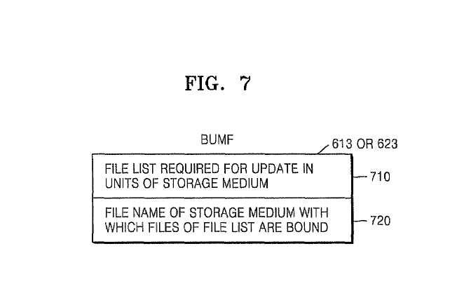

FIG. 7 shows a structure of the BUMF 613 according to an embodiment of the present invention. The BUMF 613 includes a file list 710 required for file update in units of a storage medium and a file name 720 in a storage medium with which files in the file list 710 are to be bound.

The update of a caption file and an audio file will now be explained. The file list 710 contains file names which are to be downloaded via a network and stored in a predetermined region of the local storage medium 410. The file list 710 may be exemplified as follows:

FILE LIST 710

audio_subtitle.mpls
audio1.clpi
audio1.m2ts
subtitle1.clpi
subtitle1.m2ts

The file name 720 of the storage medium indicates file names of files stored in the storage medium with which the files in the file list 710 are to be bound.

In the table below, the first column indicates the file list 710 of the downloaded files, and the second column indicates the file list of the files stored in the storage medium 402. If one of the file names in the file list 710 corresponds to a file in the storage medium 402, the corresponding file of the storage medium 402 is replaced with the downloaded file during the generation of the virtual file system. If the file name in the file list 710 does not correspond to a file in the storage medium 402, the file existing only in the file list 710 is a file that is newly supported by the virtual file system.

| | FILE NAMES OF |
|---|---|
| | CORRESPONDING FILES IN |
| FILE LIST 710 | STORAGE MEDIUM 720 |
| audio_subtitle.mpls | 00010.mpls |
| audio1.clpi | 00005.clpi |
| audio1.m2ts | 00005.m2ts |
| subtitle1.clpi | 00006.clpi |
| subtitle1.m2ts | 00006.m2ts |

FIG. 6B illustrates a second example of the update information included in the history information 500 according to an embodiment of the present invention. Update information 620 according to the second example includes studio/disc information 621, version (or downloaded content) information 622, a BUMF 623, and all of a plurality of files 624 recorded in the BUMF 623. The studio/disk information 621 and the version (or downloaded content) information 622 are the same as the studio/disk information 611 and version (or downloaded content) information 612 of FIG. 6A. Unlike the update information 610 according to the first example, the update information 620 according to the second example further includes all the files 624 recorded in the BUMF 623.

The files 624 are all the files corresponding to file names listed in the BUMF 623. The files 624 include stream files m2ts containing actually downloaded data, such as caption data and audio data, and a database file required to reproduce the stream file, such as clip information and a play list. Since all the files 624 as well as the BUMF 623 are stored as the update information 620 in the local storage medium 410, the virtual file system can be reliably generated using only the files 624 recorded in the BUMF 623. If only the BUMF 623 excluding the files 624 recorded in the BUMF 623 is stored as the update information 620 in the local storage medium 410 like the first example of the update information 610, some of the files 624 recorded in the BUMF 623 may be removed. In this case, generation of the virtual file system cannot be ensured by using only the files 624 recorded in the BUMF 623.

FIG. 6C illustrates a third example of the update information included in the history information 500 according to an embodiment of the present invention. Update information 630 according to the third example includes studio/disk information 631, version (or downloaded content) information 632, and a virtual package 633. The studio/disk information 631 and the version (or downloaded content) information 632 are the same as the studio/disk information 611 and version (or downloaded content) information 612 of FIG. 6A. The virtual package 633 is a virtual file system generated using a currently activated BUMF. The virtual package 633 denotes virtual file system information required to reproduce the data stored in the storage medium and the data downloaded via the network.

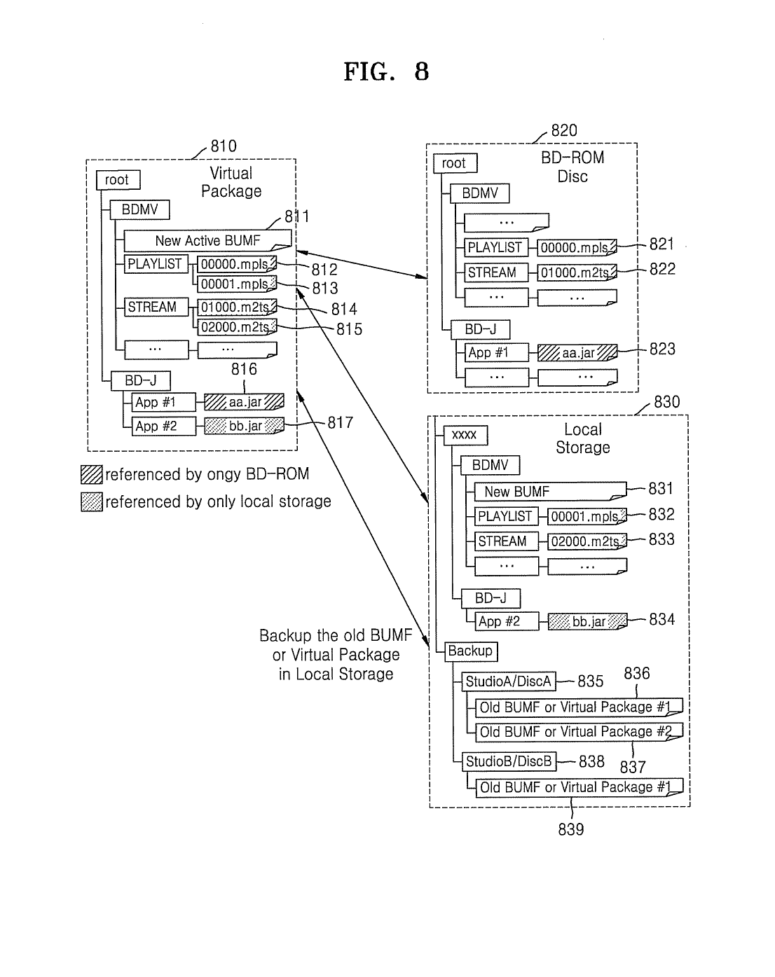

FIG. 8 is a view explaining a concept of a virtual package 810, according to an embodiment of the present invention. Data structures of the virtual package 810, a BD-ROM disk 820, and a local storage medium 830 are shown in FIG. 8. Files that are read from the BD-ROM disc 820 to be reproduced are indicated by hatching, and data that is read from the local storage medium 830 to be reproduced is indicated by dots.

The data structure of the BD-ROM disc 820 includes a play list 00000.mpls 821, a stream 01000.m2ts 822, and an application aa.jar 823. When a user desires to reproduce the BD-ROM disk 820 using data other than the data stored in the BD-ROM disk 820, new data is downloaded via a network, and a virtual file system used to reproduce the downloaded data and the data of the BD-ROM disc 820 is generated as the virtual package 810.

The virtual package 810 includes a currently activated BUMF 811, a play list 00000.mpls 812 stored in the BD-ROM disc 820, a play list 00001.mpls 813 stored in the local storage medium 830, a stream 01000.m2ts 814 stored in the BD-ROM disk 820, a stream 02000.m2ts 815 stored in the local storage medium 830, an application aa.jar 816 stored in the BD-ROM disc 820, and an application bb.jar 817 stored in the local storage medium 830.

The data currently downloaded via the network and the history information is stored in the local storage medium 830. The data currently downloaded via the network includes a new BUMF 831, a play list 00001.mpls 832, a stream 02000.m2ts 833, and an application bb.jar 834. In addition, the local storage medium 830 includes BACKUP as the history information. The BACKUP includes update information on studio A/V disc A 835 containing Old BUMF or Virtual Package #1 836 and Old BUMF or Virtual Package #2 837 and update information on studio B/disk B 838 containing Old BUMF or Virtual Package #1 839.

If the reproducing apparatus 400 changes the title or ejects the BD-ROM disk 820 during reproduction of the data of the BD-ROM disk 820 and the data of the local storage medium 830 using such a virtual file system as the virtual package 810, then the reproducing apparatus 400 stores the currently activated BUMF 811 or the virtual package 810 as BACKUP of the local storage medium 830. Since the information (such as the virtual file system) generated each time the data is downloaded via the network is stored as the update information in the local storage medium 830, the user can select the update information from the previously generated update information.

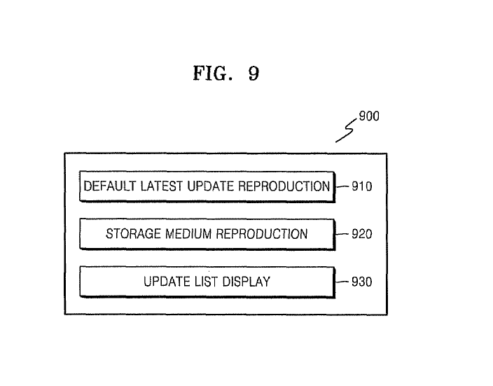

FIG. 9 shows an example of a menu screen 900 that is provided to a user so as to reproduce data based on update information stored in a local storage medium, according to an embodiment of the present invention. The menu screen 900 includes default (latest update) reproduction 910, storage medium reproduction 920, and an update list display 930. The default (latest update) reproduction 910 is associated with a user's input for reproducing data by using the latest virtual file system. The storage medium reproduction 920 is associated with a user's input for reproducing only the data stored in the storage medium without using data downloaded via a network.

The update list display 930 is associated with a user's input for displaying the update information stored in the local storage medium up to the present. When the user's input of the update list display 930 is selected, the reproducing apparatus 400 displays the list of the update information stored in the local storage medium on the menu screen. When the user selects update information from the update list, the reproducing apparatus 400 reproduces the data based on the selected update information.

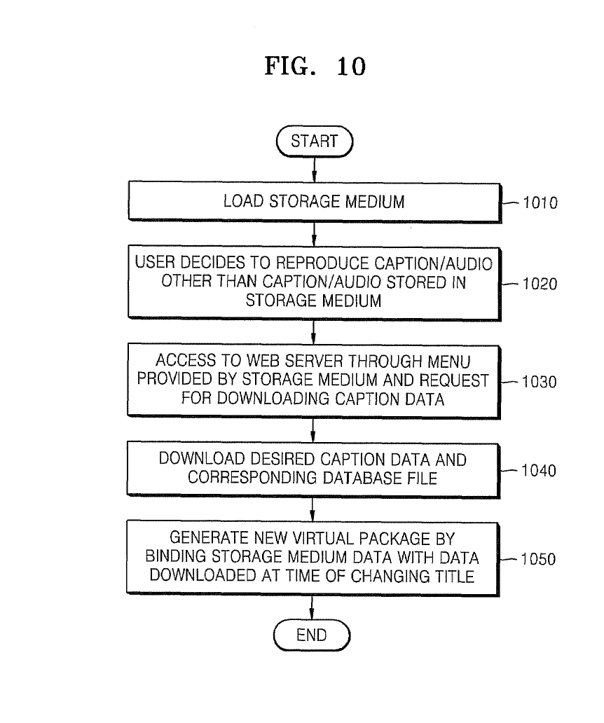

FIG. 10 is a flowchart illustrating a procedure of downloading supplementary data via a network, according to an embodiment of the present invention. In operation 1010, the user loads the storage medium 402 into the reproducing apparatus 400. The user decides to reproduce caption/audio data other than caption/audio data stored in the storage medium 402 in operation 1020. For example, the storage medium 402 may store English or French caption data, but the user may desire to reproduce Korean caption data.

The user accesses a web server through a menu, for example, provided by an application of the storage medium 402, to select and download the desired caption data from the web server in operation 1030. In response to the user's request, the desired caption stream and the database file corresponding to the caption stream are downloaded in operation 1040. The downloaded data may include all information required to update files in the storage medium 402. When the download is completed, an application informs the reproducing apparatus 400 of the completion of the download and requests the reproducing apparatus 400 to perform the update.

It may be determined whether the data before the generation of a new virtual package is suitable to update files of the storage medium 402. The determination may be performed using a BUMF downloaded during the downloading of the data. The BUMF includes a file list required to update the files of the storage medium 402 and files of the storage medium with which the corresponding files of the file list are bound. The reproducing apparatus 400 generates a new virtual package by binding the data of the storage medium 402 with the data downloaded at the time of changing the title in operation 1050.

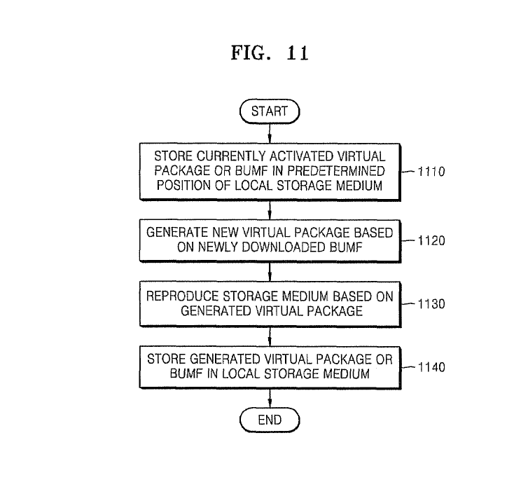

FIG. 11 is a flowchart illustrating a procedure of storing update information in the local storage medium 410, according to an embodiment of the present invention. Before a virtual package or a BUMF is updated, a currently activated BUMF is copied and stored in a predetermined region of the local storage medium 410 in operation 1110. The BUMF includes storage medium information (studio name and storage medium name) to be reproduced, virtual package version information, a file list of files to be updated in the storage medium 402, and a file name of a storage medium with which corresponding files of the file list are bound with, and, optionally, all the files in the file list.

The virtual package includes the storage medium information (studio name and storage medium name) to be reproduced and the virtual package version information. The new virtual package is generated based on a newly downloaded BUMF in operation 1120. The data in the storage medium 402 is reproduced based on the new virtual package in operation 1130. The new virtual package or BUMF is stored in the local storage medium 410 in operation 1140.

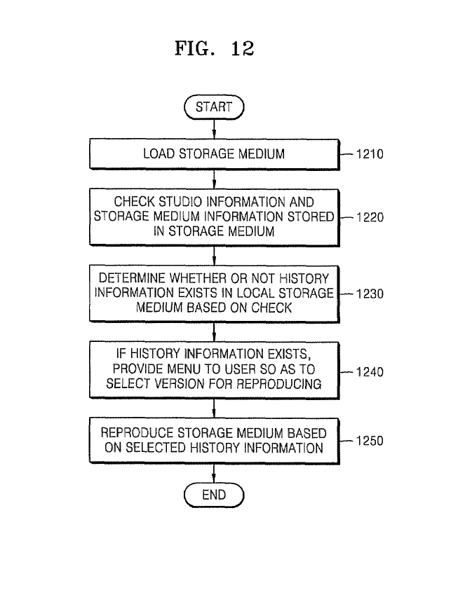

FIG. 12 is a flowchart illustrating a procedure of reproducing data based on update information stored in the local storage medium 410, according to an embodiment of the present invention. When the storage medium 402 is loaded into the reproducing apparatus 400 in operation 1210, the reproducing apparatus 400 checks studio information and storage medium information stored in the storage medium 402 in operation 1220.

Based on the studio information and storage medium information stored in the storage medium 402, whether update information corresponding to the studio information and the storage medium information in the local storage medium 410 exists is determined in operation 1230.

If history information exists in the local storage medium 410, a menu is provided to the user so as to permit the user to a select a version, in operation 1240. Although such a history selection function may be provided by the reproducing apparatus 400, the function may be provided by an application stored in the storage medium 402. The menu may be constructed as illustrated in FIG. 9, or may be constructed in another way. The default reproduction information 910 refers to reproduction of the latest update data. The storage medium reproduction 920 refers to reproduction of only the storage medium 402 using the downloaded information. The update list display 930 refers to display of all the lists that can be selected based on the update information.

Data in the storage medium 402 is reproduced based on the history information that is selected by the user. If the user selects the default reproduction 910, the data is reproduced based on the latest update information stored in the local storage medium 410. If the user selects the storage medium reproduction 920, an existing virtual package or a BUMF relating to the existing virtual package is copied in the region of the local storage medium 410 in which the history information is stored, and the virtual package is removed, so that only the data stored on the storage medium 402 can be reproduced.

If the user selects the update list display 930 to select update information stored in the local storage medium 410, the update information in the corresponding position of the local storage medium 410 is read, so that the data is reproduced. If the BUMF is stored as the update information, the reproducing apparatus 400 checks whether or not all the data in the BUMF is valid. The reproducing apparatus 400 generates a new virtual package based on the validity of the BUMF. If the data is not valid, an alarm message is displayed, and the data is reproduced based on the existing virtual package. The existing virtual package corresponds to the latest virtual package.

If the BUMF and all the files associated with the BUMF are stored as the update information, the files associated with the BUMF are copied in predetermined positions, and a new virtual package is generated based on the BUMF, so that the data can be reproduced based on the new virtual package. If the virtual package is stored as the update information, it is determined whether or not all the files indicated by the virtual package are valid. If all the files are valid, the data is reproduced based on the selected virtual package. If all the files are not valid, the data is reproduced based on the previous virtual package.

Aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to aspects of the present invention, when data is downloaded one or more times to a storage medium to update a virtual package, a user can reproduce data based on a previous virtual package or reproduce only the data stored in the storage medium without removing the newly downloaded data. Thus, various reproduction modes can be provided to a user.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to reproduce audio/video (A/V) data of an information storage medium, the apparatus comprising:
a controller to download, via a network, data used to reproduce the A/V data and to generate as update information file information used to reproduce the A/V data together with the downloaded data; and
a local storage medium to store the update information;
wherein the controller stores newly downloaded and generated update information in the local storage medium while maintaining previously downloaded and generated update information in the local storage medium.

2. The apparatus of claim 1, wherein the update information comprises studio/disk information indicating a producer of the downloaded data and a storage medium associated with the downloaded data, version information identifying the update information, and file information used to update files of the information storage medium.

3. The apparatus of claim 2, wherein the file information comprises a file list of the downloaded data required to update the files of the information storage medium and a file list of the information storage medium with which files of the downloaded data are to be bound.

4. The apparatus of claim 2, wherein the file information comprises a binding unit manifest file (BUMF).

5. The apparatus of claim 4, wherein the update information further comprises all the files indicated by the BUMF.

6. The apparatus of claim 1, wherein the update information comprises studio/disk information indicating a producer of the downloaded data and a storage medium associated with the downloaded data, version information identifying the update information, and a virtual file system information used to reproduce the A/V data together with the downloaded data.

7. The apparatus of claim 6, wherein the virtual file system information comprises a virtual package.

8. The apparatus of claim 1, wherein the downloaded data comprises stream data used by the update information, a database file corresponding to the stream data, and file information used to update files of the information storage medium.

9. The apparatus of claim 8, wherein the stream data comprises caption data, audio data, trailer data, and application data.

10. The apparatus of claim 1, wherein the controller downloads, via the network, the data used to reproduce the A/V data, and stores the previously downloaded and generated update information in the local storage medium each time the file information used to reproduce the A/V data together with the downloaded data is generated as the update information.

11. An apparatus to reproduce audio/video (A/V) data of an information storage medium, the apparatus comprising:
a local storage medium to store update information that is file information used to reproduce the A/V data, and data downloaded via a network;
an A/V decoder to decode at least one of the A/V data stored in the information storage medium and the downloaded data stored in the local storage medium; and
a controller to control the A/V decoder to decode, based on the update information, at least one of the A/V data stored in the information storage medium and the downloaded data stored in the local storage medium.

12. The apparatus of claim 11, wherein the controller provides a menu to a user to enable the user to select a reproducing mode based on the update information.

13. The apparatus of claim 11, wherein, when the controller receives from the user an input indicating that the latest update information is selected in response to providing the menu, the controller controls the A/V decoder to decode, based on the latest update information stored in the local storage medium, at least one of the A/V data stored in the information storage medium and the downloaded data stored in the local storage medium.

14. The apparatus of claim 11, wherein, when the controller receives from the user an input indicating that the A/V data stored in the information storage medium is to be reproduced in response to providing the menu, the controller controls the A/V decoder to decode the A/V data stored in the information storage medium without referring to the local storage medium.

15. The apparatus of claim 11, wherein:
when the controller receives from the user an input indicating that an update list display is selected, the controller provides to the user a list of the update information stored in the local storage medium; and
when the controller receives from the user an input indicating that the update information is selected in response to providing the list, the controller controls the A/V decoder to decode, based on the selected update information, at least one of the A/V data stored in the information storage medium and the downloaded data stored in the local storage medium.

16. The apparatus of claim 11, wherein the update information comprises studio/disk information indicating a producer of the downloaded data and a storage medium associated with the downloaded data, version information identifying the update information, and file information used to update files of the information storage medium.

17. The apparatus of claim 16, wherein the file information comprises a file list of the downloaded data required to update the files of the information storage medium and a file list of the information storage medium with which files of the downloaded data are to be bound.

18. The apparatus of claim 16, wherein the file information comprises a binding unit manifest file (BUMF).

19. The apparatus of claim 18, wherein the update information further comprises all the files indicated by the BUMF.

20. The apparatus of claim 11, wherein the update information comprises studio/disk information indicating a producer of the downloaded data and a storage medium associated with the downloaded data, version information identifying the update information, and a virtual file system used to reproduce the downloaded data and the A/V data.

21. A method of reproducing audio/video (A/V) data of an information storage medium, comprising:
downloading, via a network, data used to reproduce the A/V data;
generating as update information file information used to reproduce the A/V data together with the downloaded data; and
storing the update information in a local storage medium;
wherein newly downloaded and generated update information is stored in the local storage medium while maintaining previously downloaded and generated update information in the local storage medium.

22. The method of claim 21, wherein the update information comprises studio/disk information indicating a producer of the downloaded data and a storage medium associated with the downloaded data, version information identifying the update information, and file information used to update files of the information storage medium.

23. The method of claim 22, wherein the file information comprises a file list of the downloaded data required to update the files of the information storage medium and a file list of the information storage medium with which files of the downloaded data are to be bound.

24. The method of claim 22, wherein the file information comprises a BUMF.

25. The method of claim 24, wherein the update information further comprises all the files indicated by the BUMF.

26. The method of claim 21, wherein the update information comprises studio/disk information indicating a producer of the downloaded data and a storage medium associated with the downloaded data, version information identifying the update information, and a virtual file system information used to reproduce the downloaded data and the A/V data.

27. The method of claim 26, wherein the virtual file system information comprises a virtual package.

28. The method of claim 21, wherein the downloaded data comprises a stream data used for update, a database file corresponding to the stream data, and file information used to update files of the information storage medium.

29. The method of claim 28, wherein the stream data comprises caption data, audio data, trailer data, and application data.

30. The method of claim 21, wherein the storing of the update information comprises:
downloading, via the network, the data used to reproduce the A/V data; and
storing the previously downloaded and generated update information in the local storage medium each time the file information used to reproduce the A/V data together with the downloaded data is generated as the update information.

31. A method of reproducing audio/video (A/V) data of an information storage medium, comprising:
decoding at least one of A/V data stored in the information storage medium and downloaded data downloaded via a network and stored in a local storage medium, based on update information that is file information used to reproduce the A/V data together with the downloaded data and that is stored in the local storage medium.

32. The method of claim 31, further comprising providing a menu to a user to enable the user to select a reproducing mode based on the update information.

33. The method of claim 31, further comprising:
decoding, based on the latest update information stored in the local storage medium, at least one of the A/V data stored in the information storage medium and the downloaded data stored in the local storage medium, if an input indicating that the latest update information is selected is received from the user in response to the menu.

34. The method of claim 31, further comprising:
decoding the A/V data stored in the information storage medium without referring to the local storage medium, if input indicating that the A/V data stored in the information storage medium is to be reproduced is received from the user in response to the menu.

35. The method of claim 31, further comprising:
providing to the user a list of the update information stored in the local storage medium, if an input indicating that an update list display is selected is received from the user in response to the menu; and
when an input indicating that the update information is selected is received from the user in response to the list, decoding based on the selected update information at least one of the A/V data stored in the information storage medium and the downloaded data stored in the local storage medium.

36. The method of claim 31, wherein the update information comprises studio/disk information indicating a producer of the downloaded data and a storage medium associated with the downloaded data, version information identifying the update information, and file information used to update files of the information storage medium.

37. The method of claim 36, wherein the file information comprises a file list of the downloaded data required to update the files of the information storage medium and a file list of the information storage medium with which files of the downloaded data are to be bound.

38. The method of claim 36, wherein the file information comprises a BUMF.

39. The method of claim 38, wherein the update information further comprises all the files indicated by the BUMF.

40. The method of claim 31, wherein the update information comprises studio/disk information indicating a producer of the downloaded data and a storage medium associated with the downloaded data, version information identifying the update information, and a virtual file system information used to reproduce the downloaded data and the A/V data.

41. A computer readable medium comprising instructions that, when executed by a reproducing apparatus, cause the reproducing apparatus to perform the method of claim 31.

42. A reproducing apparatus to reproduce audio/video (A/V) data in an optical storage medium, the reproducing apparatus comprising:
a controller to download data used to reproduce the A/V data and to generate update information used to reproduce the A/V data together with the downloaded data; and
a local storage medium to store the downloaded data and history information comprising the update information and previously generated update information.

43. The reproducing apparatus of claim 42, wherein the update information comprises studio/disk information, version information, and a binding unit manifest file (BUMF) indicating file information used to update files of the optical storage medium.

44. The reproducing apparatus of claim 43, wherein the controller replaces a file stored in the local storage medium with a file in the downloaded data if the BUMF indicates that the file stored in the local storage medium corresponds to the file in the downloaded data.

45. The reproducing apparatus of claim 42, wherein the update information comprises studio/disk information, version information, a BUMF, and files corresponding to the file information indicated in the BUMF.

46. The reproducing apparatus of claim 42, wherein the update information comprises studio/disk information, version information, and a virtual package having information file information used to reproduce the A/V data and the downloaded data.

47. The reproducing apparatus of claim 46, wherein the virtual package comprises:
a currently activated BUMF;
at least one playlist stored in the optical storage medium;
at least one playlist stored in the local storage medium;
an application stored in the optical storage medium; and
an application stored in the local storage medium.

48. The reproducing apparatus of claim 42, further comprising:
an A/V decoder to decode A/V data and to reproduce the A/V data on a display;
wherein the controller controls the decoder to decode data stored in the storage medium or in the local storage medium based on update information stored in the local storage medium and selected by a user.

49. A method of reproducing audio/video (A/V) data, the method comprising:
determining whether history information is stored in a local storage medium based upon studio information and/or storage medium information stored in a removable storage medium;
providing a menu to a user so as to allow the user to select a version of the history information stored in the local storage medium; and
reproducing at least one of A/V data stored in the removable storage medium and A/V data stored in the local storage medium based on the history information selected by the user.
